(19) United States
(12) Patent Application Publication
(10) Pub. No.: US 2014/0278977 A1
(43) Pub. Date: Sep. 18, 2014

(54) SYSTEMS AND METHODS FOR COMMUNICATION CHANNEL SELECTION

(71) Applicant: Gamesys Ltd., London (GB)

(72) Inventors: Thomas Newton, London (GB); Chris Targett, Kentish Town (GB)

(73) Assignee: Gamesys Ltd., London (GB)

(21) Appl. No.: 14/210,948

(22) Filed: Mar. 14, 2014

Related U.S. Application Data
(60) Provisional application No. 61/785,675, filed on Mar. 14, 2013.

(51) Int. Cl. G06Q 30/02

(52) U.S. Cl. CPC G06Q 30/0255
USPC 705/14.53

(57) ABSTRACT

Systems, methods, and articles of manufacture provide for enhanced messaging services such as customized and/or dynamic communication channel selection.

### CROSS-REFERENCE TO RELATED APPLICATIONS

This application is a non-provisional of and claims benefit and priority under 35 U.S.C. §119(e) to, U.S. Provisional Patent Application No. 61/785,675 filed on Mar. 14, 2013 and titled “SYSTEMS AND METHODS FOR MESSAGING”, the entirety of which is hereby incorporated by reference herein.

### BACKGROUND

Maintaining communications with customers has become an increasingly important aspect of business operations, particularly for online merchants and businesses. Existing messaging systems, however, have been conducted in accordance with traditional guidelines that have failed to address various inefficiencies and problems.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a block diagram of a system according to some embodiments;

FIG. 3 is a block diagram of an example data storage structure according to some embodiments;

FIG. 4 is a flow diagram of a method according to some embodiments;

FIG. 5 is a block diagram of an apparatus according to some embodiments; and

FIG. 6A, FIG. 6B, FIG. 6C, FIG. 6D, and FIG. 6E are perspective diagrams of exemplary data storage devices according to some embodiments.

### DETAILED DESCRIPTION

### I. Introduction

Embodiments presented herein are descriptive of systems, apparatus, methods, and articles of manufacture for communication channel selection. In some embodiments, customer (or another user such as an online game player) engagement with transmitted communications (such as notifications, advertisements, and/or offers) may be gauged, ranked, scored, and/or otherwise processed and/or analyzed to determine a desired and/or appropriate communication channel via which future or additional messages/communications should be sent to the customer.

### II. Terms and Definitions

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting. While not generally limiting and while not limiting for all described embodiments, in some embodiments, the terms are specifically limited to the example definitions and/or examples provided. Other terms are defined generally throughout the present description.

A “game”, as the term is utilized herein (unless otherwise specified), may generally comprise any game (e.g., wagering or non-wagering, skill-based, chance-based, playable by hand (e.g., utilizing non-electric physical components, boards, and/or pieces), and/or electronically playable over a network) playable by one or more players in accordance with specified rules. An electronic game may be playable on a Personal Computer (PC), online in web browsers, on a game console, and/or on a mobile device such as a smart-phone or tablet computer. “Gaming” thus generally refers to play of a game (e.g., by one or more players).

A “wager-style game”, as the term is utilized herein (unless otherwise specified), generally refers to a game that is played in the same manner as a wagering game, but does not technically qualify as gambling. Casual and/or social network games may, for example, be conducted in the same manner of game play as a wagering game such as slots, but may not accept true wagers from players and/or may otherwise differ from true wagering games.

A “casual game”, as the term is utilized herein (unless otherwise specified), may generally comprise a game with simple rules with little or no time commitment on the time of a player to play. A casual game may feature, for example, very simple game play such as a puzzle or Scrabble™ game, may allow for short bursts of play (e.g., during work breaks), an ability to quickly reach a final stage and/or continuous play without a need to save the game.

A “social network game”, as utilized herein (unless otherwise specified), generally refers to a type of online game that is played through a social network, and in some embodiments may feature multiplayer and/or asynchronous game play mechanics. A “social network” may refer to an online service, online community, platform, and/or site that focuses on facilitating the building of social networks or social relations among people. A social network service may, for example, consist of a representation of each user (often a profile), his/her social links, and a variety of additional services. A social network may be web-based and provide means for users to interact over the Internet, such as e-mail and instant messaging. A social network game may in some embodiments be implemented as a web browser and/or web-client game, a Flash®, or Java®-scripted game, and/or may be implemented on one or more mobile platforms such as on portable electronic devices.

A “wagering game”, as the term is utilized herein (unless otherwise specified), may generally comprise a game in which a player can risk a wager or other consideration, such as, but not limited to: slot-style games, poker games, blackjack, baccarat, craps, roulette, lottery, bingo, keno, casino war, etc. A wager may comprise a monetary wager in the form of an amount of currency or any other tangible or intangible article having some value which may be risked on an outcome of a wagering game. “Gambling” or “wagering” generally refers to play of a wagering game.

The term “game provider”, as utilized herein (unless otherwise specified), generally refers to an entity or system of components which provides games for play and facilitates play of such game by use of a network such as the Internet or a proprietary or closed networks (e.g., an intranet or local or wide area network). For example, a game provider may operate a website which provides games in a digital format over the Internet. In some embodiments in which a game comprising a wagering game is provided, a game provider may operate a gambling website over which wagers are accepted and results (e.g., winnings) of wagering games are provided.

As utilized herein, the term “player” may generally refer to any type, quantity, and or manner of entity associated with the play of a game. In some embodiments, a player may comprise an entity conducting play of an online game, for example, may comprise an entity that desires to play a game (e.g., an entity registered and/or scheduled to play and/or an entity having expressed interest in the play of the game—e.g., a spectator) and/or may comprise an entity that configures, manages, and/or conducts a game. A player may be currently playing a game or have previously played the game, or may not yet have initiated play—i.e., a “player” may comprise a “potential player” (e.g., in general and/or with respect to a specific game). In some embodiments, a player may comprise a user of an interface (e.g., whether or not such a player participates in a game or seeks to participate in the game). In some embodiments, a player may comprise an individual (or group) that enters, joins, logs into, registers for, and/or otherwise access an online game room, session, server, and/or other particular instance and/or segmentation of an online game.

Some embodiments described herein are associated with a “player device”. “user device”, or a “network device”. As utilized herein, a “player device” or a “user device” is a subset of a “network device”. The “network device”, for example, may generally refer to any device that can communicate via a network, while the “player device” or “user device” may comprise a network device that is owned and/or operated by or otherwise associated with a player (e.g., a network device specifically configured to permit use thereof by the player, such as by receiving login credentials from the player) or other user. Examples of player, user, and/or network devices may include, but are not limited to: a PC, a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. Player, user, and/or network devices may, in some embodiments, comprise one or more network components. In some embodiments, a player device may comprise an electronic device configured to initiate, conduct, facilitate, and/or otherwise permit player participation in an electronic game.

As utilized herein, the term “network component” may refer to a player or network device, or a component, piece, portion, or combination of player or network devices. Examples of network components may include a Static Random Access Memory (SRAM) device or module, a network processor, and a network communication path, connection, port, or cable.

In addition, some embodiments are associated with a “network” or a “communication network.” As utilized herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration or type that is or becomes known. Communication networks may include, for example, devices that communicate directly or indirectly, via a wired or wireless medium such as the Internet, intranet, a Local Area Network (LAN), a Wide Area Network (WAN), a cellular telephone network, a Bluetooth® network, a Near-Field Communication (NFC) network, a Radio Frequency (RF) network, a Virtual Private Network (VPN), Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), and/or system to system (S2S).

As utilized herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard. Information may, according to some embodiments, be compressed, encoded, encrypted, and/or otherwise packaged or manipulated in accordance with any method that is or becomes known or practicable.

The term “indication”, as utilized herein (unless otherwise specified), may generally refer to any indicia and/or other information indicative of or associated with a subject, item, entity, and/or other object and/or idea. As utilized herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

A “session”, as the term is utilized herein (unless otherwise specified), may generally comprise a period of time spanning a plurality of event instances (e.g., with respect to a communication and/or game session) or turns of a game, the session having a defined start and defined end. An event instance or turn is triggered upon an initiation of, or request for, at least one result of the game by a player, such as an actuation of a “start” or “spin” mechanism, which initiation causes an outcome to be determined or generated (e.g., an RNG is contacted or communicated with to identify, generate or determine a random number to be used to determine an outcome for the event instance).

As utilized herein, the terms “outcome” and “result” should be differentiated in the present description in that an “outcome” is generally a representation of a “result”, typically comprising one or more game elements or game symbols. For example, in a “fruit themed” slot-style game, a winning outcome (i.e., an outcome corresponding to some kind of award, prize or payout) may comprise a combination of three “cherry” symbols. The “result” of this outcome may be a payout of X credits awarded to the player associated with the game. In another example, in a game in which a character moves along a game interface from a starting position to a finish position, an “outcome” of the game may comprise a symbol representing one or more movements along the interface and the “result” corresponding to this outcome may be the particular number and direction of the character's movement (e.g., three (3) spaces backwards such that the character ends up further away from the finish line). In a session embodiment, a session result may comprise a binary result (e.g., a player or game character wins or loses the session) and/or the particular award (or magnitude of award) won or earned by the player based on the session (e.g., the number of credits awarded to the player). It should be noted that the embodiments described herein encompass awards, prizes and payouts which are monetary, non-monetary, tangible or intangible.

As utilized herein, the term “virtual currency” may generally refer to an in-game currency that may be utilized as part of a game or one or more games provided by a game provider as (i) currency for making wagers, and/or (ii) to purchase or access various in-game items, features or powers (e.g., “freemium” upgrades and/or options).

A “credit balance”, as the term is utilized herein (unless otherwise specified), may generally refer to (i) a balance of currency, whether virtual currency and/or real currency, usable for making wagers and/or purchases in a game and/or (ii) another tracking mechanism for tracking a player's success or advancement in a game by deducting there from points or value for unsuccessful attempts at advancement and adding thereto points or value for successful attempts at advancement.

Some embodiments are descriptive of an “array” or “matrix” of symbols or game outcomes. As utilized herein, the terms “array” and “matrix” generally refer to a group of symbols, numbers, and/or expressions arranged in a plurality of rows and columns (or that can be readily and appropriately represented mathematically as being so arranged). In some embodiments, the term “array” is utilized to refer to a multi-dimensional matrix or combination of matrices while the term “matrix” is utilized to refer to a two-dimensional set of symbols or numbers (e.g., slot reel symbols and/or mathematical representations thereof). According to some embodiments, such as in the case that an array and/or matrix is populated with graphical game symbols, the array or matrix may be output and/or displayed (e.g., transmit to and/or rendered on a player device) as part of a game session.

### III. Systems

Turning first to FIG. 1, a block diagram of a system 100 according to some embodiments is shown. In some embodiments, the system 100 may comprise a gaming platform such as a gaming platform via which one or more multiplayer and/or online games may be played. According to some embodiments, the system 100 may also or alternatively comprise a messaging platform via which one or more customers, players, and/or other users are engaged. In some embodiments, the system 100 may comprise a plurality of user devices 102a-n in communication with and/or via a network 104. In some embodiments, a server 110 may be in communication with the network 104 and/or one or more of the user devices 102a-n. In some embodiments, the server 110 (and/or the user devices 102a-n) may be in communication with a database 140. The database 140 may store, for example, messaging data or game date (e.g., processed and/or defined by the server 110), data associated with user such as customers, potential customers, and/or players (not explicitly shown) owning and/or operating the user devices 102a-n, and/or instructions that cause various devices (e.g., the server 110 and/or the user devices 102a-n) to operate in accordance with embodiments described herein.

According to some embodiments, any or all of the components 102a-n, 104, 110, 140 of the system 100 may be similar in configuration and/or functionality to any similarly named and/or numbered components described herein. Fewer or more components 102a-n, 104, 110, 140 (and/or portions thereof) and/or various configurations of the components 102a-n, 104, 110, 140 may be included in the system 100 without deviating from the scope of embodiments described herein. While multiple instances of some components 102a-n are depicted and while single instances of other components 104, 110, 140 are depicted, for example, any component 102a-n, 104, 110, 140 depicted in the system 100 may comprise a single device, a combination of devices and/or components 102a-n, 104, 110, 140, and/or a plurality of devices, as is or becomes desirable and/or practicable. Similarly, in some embodiments, one or more of the various components 102a-n, 104, 110, 140 may not be needed and/or desired in the system 100.

The user devices 102a-n, in some embodiments, may comprise any type or configuration of electronic, mobile electronic, and or other network and/or communication devices (or combinations thereof) that are or become known or practicable. A first user device 102a may, for example, comprise one or more PC devices, computer workstations (e.g., game consoles and/or gaming computers), tablet computers, such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, one or more of the user devices 102a-n may be specifically utilized and/or configured (e.g., via specially-programmed and/or stored instructions such as may define or comprise a software application) to communicate with the server 110 (e.g., to receive and/or send messages and/or other data via the network 104).

The network 104 may, according to some embodiments, comprise a LAN, WAN, cellular telephone network, Bluetooth® network, NFC network, and/or RF network with communication links between the user devices 102a-n, the server 110, and/or the database 140. In some embodiments, the network 104 may comprise direct communications links between any or all of the other components 102a-n, 110, 140 of the system 100. The server 110 may, for example, be directly interfaced or connected to the database 140 via one or more wires, cables, wireless links, and/or other network components, such network components (e.g., communication links) comprising portions of the network 104. In some embodiments, the network 104 may comprise one or many other links or network components other than those depicted in FIG. 1. A second user device 102b may, for example, be connected to the server 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the other components 102a-n, 110, 140 of the system 100. The network 104 may comprise one or more cellular telephone networks with communication links between the user devices 102a-n and the server 110, for example, and/or may comprise the Internet (and/or a portion thereof), with communication links between the user devices 102a-n and the database 140, for example. In some embodiments, the network 104 may comprise a plurality of different communication channels as defined, described, and utilized herein.

According to some embodiments, the server 110 may comprise a device (and/or system) owned and/or operated by or on behalf of or for the benefit of a game provider (not explicitly shown) and/or other entity (e.g., a messaging service provider; also not explicitly shown). A game provider may utilize user, customer, player and/or game information or instructions (e.g., stored by the database 140), in some embodiments, to host, manage, analyze, design, define, price, conduct, and/or otherwise provide (or cause to be provided) one or more games such as online multiplayer games. A messaging service provider may utilize user, customer, player and/or game information or instructions (e.g., stored by the database 140), in some embodiments, to send and receive messages and/or other communications data, analyze, score, rank, and/or otherwise process customer, user, and/or player engagement with such messages/data, and/or select and/or define one or more communications channels, as described herein. In some embodiments, the game/message provider (and/or a third-party; not explicitly shown) may provide an interface (not shown in FIG. 1) to and/or via the user devices 102a-n. The interface may be configured, according to some embodiments, to allow and/or facilitate electronic game play by one or more players and/or to allow and/or facilitate user messaging and/or communications. In some embodiments, the system 100 (and/or interface provided by the server 110) may present game data (e.g., from the database 140) in such a manner that allows players to participate in one or more online games (singularly, in/with groups, and/or otherwise). In some embodiments, the system 100 (and/or interface provided by the server 110) may present message and/or communication data (e.g., from the database 140) in such a manner that enhances messaging of users, customer, and/or players. According to some embodiments, the server 110 may cause and/or facilitate play of one or more games being associated with (e.g., triggering) one or more messages sent via specially-selected communications channels, as described herein.

In some embodiments, the database 140 may comprise any type, configuration, and/or quantity of data storage devices that are or become known or practicable. The database 140 may, for example, comprise an array of optical and/or solid-state hard drives configured to store messaging, communications, customer, player and/or game data, and/or various operating instructions, drivers, etc. While the database 140 is depicted as a stand-alone component of the system 100 in FIG. 1, the database 140 may comprise multiple components. In some embodiments, a multi-component database 140 may be distributed across various devices and/or may comprise remotely dispersed components. Any or all of the user devices 102a-n may comprise the database 140 or a portion thereof, for example, and/or the server 110 may comprise the database 140 or a portion thereof.

According to some embodiments, any or all of the user devices 102a-n in conjunction with one or more of the server 110 and/or the database 140 (e.g., via the network 104) may conduct (in whole or in part), facilitate, and/or otherwise be associated with execution of one or more stored procedures, applications, processes, and/or methods (e.g., the method 400 of FIG. 4 herein, and/or one or more portions thereof) as described herein.

Referring now to FIG. 2, a block diagram of a system 200 according to some embodiments is shown. In some embodiments, the system 200 may comprise a gaming and/or messaging platform such as a platform via which social, multiplayer, and/or online games may be played and/or a platform via which enhanced messaging services as described herein are provided. In some embodiments, the system 200 may comprise a plurality of user and/or player devices 202a-b in communication with one or more of a plurality of communication channels 204a-c, and/or a third-party device 206. According to some embodiments, the user and/or player devices 202a-b may be owned and/or operated by and/or otherwise associated with one or more user and/or players 208a-b (e.g., a user 208a and/or a player 208b). In some embodiments, the system 200 may comprise a server 210 in communication with (or comprising) a plurality of data storage devices 240a-e. The data storage devices 240a-e may comprise, for example, a distribution database 240a, a message template database 240b, an actions database 240c, a jobs database 240d, and/or a communication channel database 240e.

According to some embodiments, any or all of the components 202a-b, 204a-c, 206, 208a-b, 210, 240a-e of the system 200 may be similar in configuration and/or functionality to any similarly named and/or numbered components described herein. Fewer or more components 202a-b, 204a-c, 206, 208a-b, 210, 240a-e (and/or portions thereof) and/or various configurations of the components 202a-b, 204a-c, 206, 208a-b, 210, 240a-e may be included in the system 200 without deviating from the scope of embodiments described herein. While multiple instances of some components 202a-b, 204a-c, 208a-b, 240a-e are depicted and while single instances of other components 206, 210 are depicted, for example, any component 202a-b, 204a-c, 206, 208a-b, 210, 240a-e depicted in the system 200 may comprise a single device, a combination of devices and/or components 202a-b, 204a-c, 206, 208a-b, 210, 240a-e, and/or a plurality of devices, as is or becomes desirable and/or practicable. Similarly, in some embodiments, one or more of the various components 202a-b, 204a-c, 206, 208a-b, 210, 240a-e may not be needed and/or desired in the system 200.

According to some embodiments, the server 210 may be configured (i.e., specially-programmed) to send messages such as notifications, advertisements, and/or offers to the users and/or players 208a-b. The user 208a may, for example, comprise a customer or potential customer for which the server 210 is configured to send one or more advertisements and/or offers such as coupons, discount codes, and/or special pricing and/or product packaging deals (e.g., free shipping offers and/or buy-one-get-one-free offers). In some embodiments, the player 208b may comprise a player of an online game (such as an online game facilitated and/or conducted by the server 210 and/or the third-party device 206) for which the server 210 is configured to send one or more messages such as game-related messages, offers, prizes, etc. In some embodiments, the game server 210 may access one or more of the data storage devices 240a-e and utilize data retrieved therefrom to determine (i) which of the communication channels 204a-c to utilize to send a message, (ii) which user and/or player device 202a-b to send a message to, and/or (iii) when (e.g., at what times, dates, days of the week or month, seasons, etc.) to send one or more messages.

According to some embodiments, the sever 210 may access the distribution database 240a (e.g., a first database) to determine one or more users and/or players 208a-b to which a message should be sent. The distribution database 240a may store, for example, one or more message distribution lists, user listings, and/or player listings or rankings (e.g., leader boards and/or standings). In some embodiments, the distribution database 240a may store data descriptive of a group, team, and/or population of users and/or players 208a-b such as potential customers, current customers, current customers satisfying a particular criteria (e.g., current customers that have not been contacted within a particular threshold amount of time; e.g., twenty (20) days), players currently playing, players currently playing a particular game, players meeting a particular game play requirement, and/or players (or other users) that are currently logged into an online account (and/or are otherwise known to be online).

In some embodiments, the sever 210 may access the message template database 240b (e.g., a second database) to determine particular formats, content, and/or other features that should be utilized to assemble and/or generate communications to be sent to members of a distribution list. Template data may, for example, define various data fields (e.g., tokens and/or placeholders), variables, tags, metadata, headings, addresses, sections, hyperlinks, media (e.g., sounds, photos, video), and/or other components that should be included in a particular type of message. In some embodiments, the template data may define a type and/or format for a particular type of message such as an identification of one of a plurality of electronic file formats, transmission protocols, encoding sequences or protocols, compression algorithms, etc. In some embodiments, the message template database 240b may store information defining various messaging characteristics or features such as message length criteria, transmission language (e.g., English, French), and/or an indication of whether a message comprises a “push” or “pull” notification type.

According to some embodiments, the sever 210 may access the actions database 240c (e.g., a third database) to determine one or more tasks that should be accomplished with respect to a particular user and/or player 208a-b (or a particular group, team, user account, device, etc.). Various tasks such as, but not limited to, sending an e-mail, sending a push notification, editing an aspect of a user's profile, and/or awarding a user and/or player 208a-b (e.g., with a particular benefit) may, for example, be stored in association with data descriptive of a particular user and/or player 208a-b—e.g., as identified by a distribution list. According to some embodiments, a tasks may comprise an updating and/or setting of a variable, value, and/or data component such as an engagement score of a user and/or player 208a-b, as described herein.

In some embodiments, the sever 210 may access the jobs database 240d (e.g., a fourth database) to determine a set of actions/tasks to be carried out for a particular user and/or player 208a-b (or a particular group, team, user account, device, etc.). The jobs database 240d may, for example, store task priorities, task variable values, execution times, and/or trigger definitions. According to some embodiment, such jobs data may comprise and/or be utilized to establish a task completion (e.g., job) schedule and/or event-based trigger list or register that governs how and/or when various tasks are to be executed. In some embodiments, the jobs data may define one or more triggers that cause a task such as an engagement scoring procedure or routine to be executed (e.g., upon the server 210 receiving new engagement data descriptive of a level of communications engagement of the user and/or player 208a-b).

According to some embodiments, the sever 210 may access the communication channel database 240e (e.g., a fifth database) to determine one or more available communications channels (such as the communications channels 204a-c) via which the user and/or player 208a-b may be contacted (e.g., a message in accordance with a particular template may be transmitted). The communication channels 204a-c and/or any other available channels identified by the communication channel database 240e may generally comprise, for example (but are not limited to), e-mail channels, telephone channels (e.g., a Public Switched Telephone Network (PSTN) channel), cellular telephone channels, satellite telephone channels, conventional postal courier channels (e.g., ‘snail mail’), text-messaging channels (e.g., a Short Message Service (SMS) channels), push and/or pull notification channels, and/or application-specific channels (e.g., the Messenger™ utilized by the Facebook® application, available from Facebook®, Inc. of Menlo Park, Calif.). According to some embodiments, the communication channels 204a-c may comprise channels of the same type (e.g., several e-mail channels) that are associated with different service providers (e.g., different Internet Service Provider (ISP) and/or hosted and/or web-based e-mail hosting entities), different delivery targets (e.g., a first user device 202a-1 as opposed to a second user device 202a-2), and/or different timing constraints and/or settings.

In some embodiments, the server 210 may utilize any or all data stored in the data storage devices 240a-e to determine when, where, and/or how to send a message and/or other communication to one or more of the user and/or player 208a-b. According to some embodiments, such as in the case that a first message is being sent to the user 208a, one of the available communications channels 204a-c may be chosen randomly, in a round-robin fashion, and/or based on some preliminary data and/or logic stored in one or more of the data storage devices 240a-e. In some embodiments, once a message has been sent to the user 208a and/or the player 208b, information descriptive of an engagement with the message may be sensed, retrieved, queried, stored, and/or otherwise provided to the server 210. In the case of a first e-mail message sent via a first communication channel 204a to the first user device 202a-1 (of the user 208a), for example, information descriptive of whether the user 208a opened the message, deleted the message, clicked on a link in the message, and/or replied to the message may be transmitted back to the server 210 (e.g., via the first user device 202a-1 and/or the first communication channel 204a).

In the case of a second e-mail message sent via a second communication channel 204b to the second user device 202a-2 (of the user 208a), for example, information descriptive of whether the message was bounced (e.g., rejected), marked as spam or junk (or otherwise filtered), and/or viewed by the user 208a (e.g., via a message alert preference of the second user device 202a-2 that causes certain messages to be output; and/or requires user input to “clear” from an output screen) may be transmitted back to the server 210 (e.g., via the first user device 202a-1 and/or the first communication channel 204a). In some embodiments, engagement data may be received via one or more channels and/or methods other than one of the available communications channels 204a-c. In the case that an in-game message is transmitted to the player device 202b (of the player 208b) via a third communications channel 204c, for example, engagement data may be sent back to the server 210 by and/or via the third-party device 206. The third-party device 206 may, for example, comprise a third-party gaming server, account provider, and/or messaging or networking service that gathers and/or retrieves engagement data from the player 208b.

According to some embodiments, the server 210 may utilize the engagement data to determine (i) what type of message to send to the user and/or player 208a-b, (ii) which device to send the message to (e.g., the first user device 202a-1 or the second user device 202a-2), (iii) which communication channel 204a-c to use to send the message, and/or (iv) at what time to send the message. Different message types, formats, and/or content stored in the message template database 240b may, for example, be associated with stored rules and/or logic (e.g., criteria) defining what types of messages and/or what message content should be sent to user and/or players 208a-b, based on various characteristics and/or preferences thereof. In the case that the user 208a has not opened any Hyper-Text Markup Language (HTML) formatted e-mails that have been sent, for example, it may be determined that an appropriate e-mail format type for future communications to the user 208a should instead be in Rich-Text Format (RTF). According to some embodiments, other message characteristics that have not elicited successful and/or desired responses from the user 208a may also or alternatively be altered and/or cycled—e.g., instead of pull notifications that have gone un-read, try push notifications, or instead of offering free shipping, try a discount (e.g., different message content).

In some embodiments, one or more available user and/or player devices 202a-b may be chosen or selected for message transmittal. In the case that the user 208a has a history of clicking on links in messages provided via the first user device 202a-1, for example, but does not appear to open messages sent to the second user device 202a-2 (or does not open or respond to them with as high a frequency), the first user device 202a-n may be selected as the most likely target for a successful communication to the user 208a. In some embodiments, selection and/or identification of a desired user and/or player device 202a-b may define a selection of one of the available communication channels 204a-c. In the case that the first user device 202a-1 can only be contacted via the first communication channel 204a, for example, the selection of the first user device 202a-1 as the target necessarily implicates usage of the first communication channel 204a.

According to some embodiments, such as in the case that multiple communications channels 204a-c may be utilized to communicate with a user and/or player device 202a-b and/or a user and/or player 208a-b, the server 210 may select one or more communication channels 204a-c via which a message should be sent. In some embodiments, communications channels 204a-c may be selected based on likelihood of successful engagement of the user and/or player 208a-b, such as based on historical engagement data. In the case that the first communication channel 204a has only elicited a response from the user 208a fifty percent (50%) of the time but the second communication channel 204b has elicited a response seventy-five percent (75%) of the time, for example, the second communication channel 204b may be chosen for future (or at least for the next) messaging attempt due to a higher historical likelihood of receiving a response from the user 208a via the second communication channel 204b.

In some embodiments, the communications channels 204a-c may be chosen and/or selected based on characteristics of the communication channels 204a-c (alone or in combination with characteristics, scores, ratings of the user and/or player 208a-b). Some communications channels 204a-c such as e-mail or messaging channels may, for example, have certain requirements such as a minimum threshold level of Click-Through-Rate (CTR) required and/or a maximum number of messages from an originating entity (e.g., the server 210) per unit of time. Such metrics may be descriptive of a “reputation”, “health”, or “cleanliness” score or rating for a particular sender utilizing such communications channels 204a-c. In such embodiments, it may be desirable to maintain the “reputation”, “health”, and/or “cleanliness” of a particular communication channel 204a-c by managing the messages sent via such communication channels 204a-c. According to some embodiments, such management may comprise selecting a particular communication channel 204a-c for a particular message and/or sent to a particular user and/or player 208a-b. In the case that the first communication channel 204a is associated with a CTR that is within a predetermined range of falling below an acceptable CTR threshold, for example, the first communication channel 204a may only be selected for user in the case that an engagement level (e.g., score or rating) of the user 208a is above of a predefined threshold level.

According to some embodiments, the server 210 may also or alternatively determine an appropriate and/or desired time to send a message to the user and/or player 208a-b. Messaging feedback received by sending messages to the player 208b, for example, may indicate that the player 208b often (e.g., more often than not; i.e., greater than fifty percent (50%) of the time; or some other frequency that outranks frequencies for other time-of-day windows) responds to messages sent between two different times of day (e.g., a first time (“T1”) and a second time (“T2”) as depicted via the timeline in FIG. 2). In such a case, a third time of day (“T3”), falling between T1 and T2 may be identified as an appropriate time to send a message to the player 208b. According to some embodiments, various combinations of desirable times, target devices, message types, and/or communication channels 204a-c may be selected, determined, identified, calculated, and/or otherwise determined by the server 210 (e.g., based on user and/or player 208a-b message engagement feedback data and/or characteristic data for one or more of the communication channels 204a-c).

According to some embodiments, any or all of the player devices 202a-b in conjunction with one or more of the third-party device 206, the server 210, and/or the databases 240a-e (e.g., via one or more of the communication channels 204a-c) may conduct (in whole or in part), facilitate, and/or otherwise be associated with execution of one or more stored procedures, applications, processes, and/or methods (e.g., the method 400 of FIG. 4 herein, and/or one or more portions thereof) as described herein.

### IV. Data Storage Structures

Referring to FIG. 3, a diagram of an example data storage structure 340 according to some embodiments are shown. In some embodiments, the data storage structure 340 may comprise a plurality of data tables such as a user table 340a and/or a communication channel table 340b. The data tables 340a-b may, for example, be utilized (e.g., at 404 of the method 400 of FIG. 4) to determine one or more of (i) a message type, (ii) a message target, (iii) a communication channel, and (iv) a messaging time, to utilize to transmit a message to a user.

The user table 340a may comprise, in accordance with some embodiments, a user IDentifier (ID) field 344a-1, a user device ID field 344a-2, a device type field 344a-3, a time field 344a-4, a communication channel field 344a-5, and/or an engagement score field 344a-6. Any or all of the ID fields 344a-1, 344a-2, 344a-5 may generally store any type of identifier that is or becomes desirable or practicable (e.g., a unique identifier, an alphanumeric identifier, and/or an encoded identifier). As an example of how the example data structure 340 may be utilized in accordance with some embodiments, the first and second records in the user table 340a (i.e., both records corresponding to the same user “1234-5678”) may indicate that for a particular device (e.g., “MAC02933FT” or “SF73HH3”, respectively) of a particular type (e.g., an iPhone® or a TV, respectively) at a particular time (e.g., on Monday or at eighteen hundred and thirty-five hours (18:35), respectively) and via a particular communications channel (e.g., “FBMSGR003” or “CABLE-DS77”, respectively), that the particular user's engagement with such communications ranked or scored a ninety-five (95) or “GOOD”, respectively. Such information may be utilized as described herein for example, to determine how, when, and/or where to send future messages to the particular user.

The communication channel table 340b may comprise, in accordance with some embodiments, a communication channel ID field 344b-1, a communication channel type field 344b-2, a cleanliness score field 344b-3, a cleanliness requirement field 344b-4, and/or a minimum engagement score field 344b-5. In some embodiments, the cleanliness score field 344b-3 may store an indication of a rank, score, metric, and/or other value indicative of a rating, level, and/or status of each particular communications channel. The value for the cleanliness score for the first-listed communications channel (“FBMSGR003”) stored in the cleanliness score field 344b-3 may indicate, for example, an eighteen percent (18%) CTR—e.g., based on user engagement feedback received subsequent to messages being sent to users via the first-listed communications channel. The cleanliness requirement field 344b-4 may, according to some embodiments, store a value indicative of a threshold, criteria, and/or other requirement or goal associated with the communications channels. The value for the cleanliness requirement for the first-listed communications channel (“FBMSGR003”) stored in the cleanliness requirement field 344b-4 may indicate, for example, a seventeen percent (17%) CTR threshold. According to some embodiments, since the current CTR (or other measurement and/or characterization metric) is very near the requirement threshold (e.g., eighteen percent (18%) CTR compared to, for example, a minimum allowable CTR of seventeen percent (17%)), messages sent via the first-listed communications channel may be selected in a manner that will increase the likelihood that the cleanliness of the communication channel will be preserved. As indicated by the minimum engagement score field 344b-5, for example, messages sent utilizing the first-listed communications channel may be limited to those messages being sent to users having an engagement score (e.g., score, rank, value, label) at or above ninety (90). In such a manner, for example, only messages being sent to users that have a relatively high likelihood of engaging with the sent messages will be sent via such a communication channel (e.g., a communication channel that is within a predetermine range of value and/or estimated time of falling below a reputation, cleanliness, and/or healthiness threshold). In some embodiments, threshold and/or trigger values such as values indicating when a communication channel is deemed to be in danger of losing a desired reputational ranking may also or alternatively be stored in the communication channel table 340b. Any of such information may be utilized as described herein for example, to determine how, when, and/or where to send future messages to the particular user, user group, etc.

In some embodiments, fewer or more data fields than are shown may be associated with the data tables 340a-b. Only a portion of one or more databases and/or other data stores is necessarily shown in FIG. 3, for example, and other database fields, columns, structures, orientations, quantities, and/or configurations may be utilized without deviating from the scope of some embodiments. Further, the data shown in the various data fields is provided solely for exemplary and illustrative purposes and does not limit the scope of embodiments described herein.

### V. Methods

Referring now to FIG. 4, a flow diagram of a method 400 according to some embodiments is shown. In some embodiments, the method 400 may be performed and/or implemented by and/or otherwise associated with one or more specialized and/or computerized processing devices (e.g., the user and/or player devices 102a-n, 202a-b and/or the servers and/or apparatus 110, 210, 510 of FIG. 1, FIG. 2, and/or FIG. 5 herein), specialized computers, computer terminals, computer servers, computer systems and/or networks, and/or any combinations thereof (e.g., by one or more online game providers, online gaming player processing devices, and/or online messaging services and/or devices). In some embodiments, the method 400 may be embodied in, facilitated by, and/or otherwise associated with various input mechanisms and/or interfaces.

The process and/or flow diagrams described herein do not necessarily imply a fixed order to any depicted actions, steps, and/or procedures, and embodiments may generally be performed in any order that is practicable unless otherwise and specifically noted. Any of the processes and/or methods described herein may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processing device) result in performance according to any one or more of the embodiments described herein.

In some embodiments, the method 400 may comprise determining (e.g., by a processing device and/or via an electronic communications network device) a communication engagement score, at 402. Activities (or lack thereof) of a customer, potential customer, game player, and/or other user may, for example, be analyzed to determine (e.g., calculate) a level of responsiveness and/or engagement of the user with respect to communications sent to the user. An engagement score may comprise, in some embodiments, a quantitative and/or qualitative rating of a user's engagement with communications. According to some embodiments, the score may be calculated and/or determined based on engagement data (e.g., messaging feedback) received in response to a message sent to a recipient. An e-mail communication channel utilized to send a message to a recipient may, for example, provide feedback regarding whether the recipient received the message, opened the message, viewed the message, clicked on a link or other feature in the message, deleted the message, characterized the message as junk or spam, flagged the message, forwarded the message, opened and attachment of the message, and/or responded to the message.

According to some embodiments, the engagement score may be determined with respect to various communication channel aspects such as (but not limited to): (i) an identification of a particular communication channel; (ii) an identification of a particular device to which the message was sent and/or upon which the message was received, viewed, etc.; (iii) an identification of a particular time of day, day of the week, month, season, etc. during which the message was sent, received by the recipient, and/or engaged with by the recipient; (iv) an identification of a particular type of message and/or message feature or content of the message; and/or (v) an identification of an external messaging factor such as a weather condition occurring at a particular location associated with the sending, receiving, and/or engagement with the message. In some embodiments, the engagement score may represent and/or be defined by various mathematical and/or logical algorithms as is or becomes desirable and/or practicable. The engagement score may, for example, identify a percentage of messages that are engaged with by a recipient (e.g., with respect to a total number of messages sent to the recipient) such as a score of fifty (50) or five tenths (0.50) to represent a fifty-percent (50%) rate of engagement. According to some embodiments, the engagement score may represent an actual value such as the example five tenths (0.50) comprising the ratio of engaged messages to total messages, an actual observed CTR, e.g., of nineteen percent (19%) for example, and/or a total number of messages engaged with (e.g., three hundred (300)) and/or the total number of engagements per unit of time (e.g., three hundred engagements per year (300/yr)). In some embodiments, the engagement score may comprise a qualitative identified and/or classification such as “GOOD”, “BAD”, “ACCEPTABLE”, “LOW PRIORITY”, etc., based on one or more variable and/or parameter thresholds. According to some embodiments, the engagement score may be defined based on individual and/or particularly grouped communication channel parameters such as an engagement score for a single particular communication channel, an engagement score for each utilized communication channel, an engagement score for all SMS-type communication channels, an engagement score for particular devices utilized by the user, and engagement score for particular times of day, days of the week, etc., and/or an engagement score based on user and/or user device location (e.g., at a time when messages are sent to the recipient, received by the recipient, and/or engaged with by the recipient).

According to some embodiments, the method 400 may comprise selecting (e.g., by the processing device and/or via the electronic communications network device) a communication channel, at 404. In the case that a message is desired to be sent to a particular recipient (e.g., customer, player, and/or user), for example, the engagement score of the recipient (e.g., determined at 402) may be utilized to select one or more of: (i) a target communication channel; (ii) a target device; (iii) a target messaging time; and/or (iv) a target message format/content. Stored criteria (e.g., rules, logic, thresholds) may be applied, for example, to determine which available communication channel, device, time, and/or message type should be utilized to send an electronic communication to the recipient. In some embodiments, such as in the case that the recipient is associated with multiple communication channel-specific engagement scores, such scores may be ranked to determine a communication channel (and/or device, time, and/or message type) with the highest score. According to some embodiments, such highest-ranked channel, device, time, message type may be selected as the target via which the message should be sent. In some embodiments, two or more of a target channel, device, time, and/or message type may be selected based on the engagement score(s). In such a manner, for example, communication methods (e.g., a combination of target channel, device, time, and/or message type) may be defined based on a likelihood that the recipient will engage with the message—thereby enhancing the likely effectiveness of the messaging system.

According to some embodiments, target communication channel attributes (e.g., channel, device, time, message type) may be selected and/or stored for a plurality of recipients, such as via distribution list management. In the case of mass-messaging campaigns, for example, a particular message may be desired to be sent to a plurality of recipients such as recipients meeting certain criteria. In the case of a gaming provider messaging system, for example, all players that were logged in and/or playing a game during a particular window of time may be desired to be contacted (e.g., to inform such players that they have won a prize, qualify for an event, etc.). In such cases, a stored distribution list (or other player/user listing) may be queried utilizing filter logic to select a subset of the recipients meeting the desired criteria. In some embodiments, the query and/or processing may result in a definition of a distribution list. In the case that a message is desired to be sent to all players who installed a particular game application within the last twenty-four (24) hours, for example, a query to a database may be structured in accordance with the following pseudo query:

SELECT player_id, install_date, email_address
FROM players
WHERE install_date = yesterday( )

Such a query may result in a subset listing of available players to contact and such a resulting distribution list may be stored and/or defined, for example, as a “recently installed” or “new player” distribution list.

According to some embodiments, a filtered listing and/or subset-defined distribution list may then be utilized to define channels of communication that are desired for such communications. In some embodiments, such as in the case that a distribution list is defined based on engagement scores and/or engagement scoring criteria, the list may be utilized to define message recipients for a given communication channel. In the case that it is known that a given communication channel such as an app-to-user communication channel (e.g., such as the Facebook® app-to-user messaging service) has a reputational threshold, for example, potential recipients may be filtered to ensure that the reputational rating of the communication channel remains above any required metric levels. In the case that a particular channel has a minimum CTR threshold of thirty percent (30%), for example, potential recipients may be filtered to only select these recipients having evidenced CTR values equal to or in excess of the reputational threshold. According to some embodiments, communication channel reputational, cleanliness, and/or healthiness parameters may be allowed to fluctuate and/or filters or limits may only be imposed if certain threshold levels of reputational values are reached. In the example case of the minimum CTR threshold of thirty percent (30%), for example, no limits or filters may be imposed on the utilization of the communication channel until the current CTR drops below forty percent (40%)—e.g., a ten percent (10%) threshold buffer from the minimum allowed level. According to some embodiments, communication channels nearing critical metric levels (e.g., that will soon be likely to experience service disruptions due to low reputational rankings or scores) may be specifically avoided or locked-out—e.g., to preserve the current reputational ranking and/or to engage recipients through other channels that are more likely to be available for future communications (e.g., particularly, in some cases, for higher-value recipients and/or recipients having higher-ranked levels of engagement, so as to avoid such recipients becoming accustomed to receiving communications via a dying channel).

In some embodiments, the method 400 may comprise sending (e.g., by the processing device and via the selected communication channel) a message, at 406. The message and/or other electronic communication may, for example, be transmitted in accordance with the various target attributes selected at 404. The message may be formatted in accordance with a particularly selected target message format, type, and/or content, for example, and addressed to recipients from a particular target distribution list (e.g., a criteria-based sub-listing of all available recipients). The message may, in some embodiments, be further addressed and/or directed to or formatted for a particular device for one or more of the recipients (e.g., a recipient's cellphone as opposed to the recipient's hone phone). According to some embodiments, the timing of the message transmission may be particularly structured and/or defined (e.g., in accordance with a target time selected at 404). The message may be scheduled, queued, and/or otherwise timed in accordance with desired pre-stored time-based parameters (e.g., scheduled for noon transmittal or estimated receipt since transmittals at noon and/or to particular recipients at noon are associated with higher engagement levels or scheduled to transmit periodically, such as every night at 11:00 PM—e.g., in a particular time zone), for example, and/or triggered by an occurrence of one or more events. Messages may be triggered, for example, based on user locations, player gaming activity events, and/or weather and/or other external events.

### VI. Apparatus and Article of Manufacture

Turning to FIG. 5, a block diagram of an apparatus 510 according to some embodiments is shown. In some embodiments, the apparatus 510 may be similar in configuration and/or functionality to any of the user and/or player devices 102a-n, 202a-b and/or the servers and/or apparatus 110, 210, 510 of FIG. 1, FIG. 2, and/or FIG. 5 herein, and/or may otherwise comprise a portion of the systems 100, 200, 500 of FIG. 1, FIG. 2, and/or FIG. 5 herein. The apparatus 510 may, for example, execute, process, facilitate, and/or otherwise be associated with the method 400 of FIG. 4 herein, and/or one or more portions thereof. In some embodiments, the apparatus 510 may comprise a processing device 512, an input device 514, an output device 516, a communication device 518, an interface 520, a memory device 540 (storing various programs and/or instructions 542 and data 544), and/or a cooling device 550. According to some embodiments, any or all of the components 512, 514, 516, 518, 520, 540, 542, 544, 550 of the apparatus 510 may be similar in configuration and/or functionality to any similarly named and/or numbered components described herein. Fewer or more components 512, 514, 516, 518, 520, 540, 542, 544, 550 and/or various configurations of the components 512, 514, 516, 518, 520, 540, 542, 544, 550 be included in the apparatus 510 without deviating from the scope of embodiments described herein.

According to some embodiments, the processing device 512 may be or include any type, quantity, and/or configuration of electronic and/or computerized processor that is or becomes known. The processing device 512 may comprise, for example, an Intel® IXP 2800 network processor or an Intel® XEON™ Processor coupled with an Intel® E7501 chipset. In some embodiments, the processing device 512 may comprise multiple inter-connected processors, microprocessors, and/or micro-engines. According to some embodiments, the processing device 512 (and/or the apparatus 510 and/or portions thereof) may be supplied power via a power supply (not shown) such as a battery, an Alternating Current (AC) source, a Direct Current (DC) source, an AC/DC adapter, solar cells, and/or an inertial generator. In the case that the apparatus 510 comprises a server such as a blade server, necessary power may be supplied via a standard AC outlet, power strip, surge protector, a PDU, and/or Uninterruptible Power Supply (UPS) device.

In some embodiments, the input device 514 and/or the output device 516 are communicatively coupled to the processing device 512 (e.g., via wired and/or wireless connections and/or pathways) and they may generally comprise any types or configurations of input and output components and/or devices that are or become known, respectively. The input device 514 may comprise, for example, a keyboard that allows an operator of the apparatus 510 to interface with the apparatus 510 (e.g., by a messaging system programmer and/or manager). In some embodiments, the input device 514 may comprise a sensor configured to provide information such as message engagement data to the apparatus 510 and/or the processing device 512. The output device 516 may, according to some embodiments, comprise a display screen and/or other practicable output component and/or device. The output device 516 may, for example, provide the interface 520 to a player (e.g., via a website and/or electronic communications network device). According to some embodiments, the input device 514 and/or the output device 516 may comprise and/or be embodied in a single device such as a touch-screen monitor (e.g., a device capable of both receiving input and providing output).

In some embodiments, the communication device 518 may comprise any type or configuration of communication device that is or becomes known or practicable. The communication device 518 may, for example, comprise a network interface card (NIC), a telephonic device, a cellular network device, a router, a hub, a modem, and/or a communications port or cable. In some embodiments, the communication device 518 may be coupled to provide data to a player device (not shown in FIG. 5), such as in the case that the apparatus 510 is utilized to provide the interface 520 to a player as described herein. The communication device 518 may, for example, comprise a cellular telephone network transmission device that sends signals indicative of messaging components to customer and/or subscriber handheld, mobile, and/or telephone device. According to some embodiments, the communication device 518 may also or alternatively be coupled to the processing device 512. In some embodiments, the communication device 518 may comprise an IR, RF, Bluetooth™, NFC, and/or Wi-Fi® network device coupled to facilitate communications between the processing device 512 and another device (such as a user/player device and/or a third-party device).

The memory device 540 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 540 may, according to some embodiments, store one or more of game instructions 542-1 and/or messaging instructions 542-2. In some embodiments, the game instructions 542-1 and/or the messaging instructions 542-2 may be utilized by the processing device 512 to provide output information via the output device 516 and/or the communication device 518.

According to some embodiments, the game instructions 542-1 may be operable to cause the processing device 512 to process player data 544-1, communications data 544-2, game data 544-3, tournament data 544-4, and/or prize data 544-5. Player data 544-1, communications data 544-2, game data 544-3, tournament data 544-4, and/or prize data 544-5 received via the input device 514 and/or the communication device 518 may, for example, be analyzed, sorted, filtered, decoded, decompressed, ranked, scored, plotted, and/or otherwise processed by the processing device 512 in accordance with the game instructions 542-1. In some embodiments, player data 544-1, communications data 544-2, game data 544-3, tournament data 544-4, and/or prize data 544-5 may be fed by the processing device 512 through one or more mathematical and/or statistical formulas and/or models in accordance with the game instructions 542-1 to provide various online games comprising and/or being associated with enhanced messaging services as described herein.

In some embodiments, the messaging instructions 542-2 may be operable to cause the processing device 512 to process player data 544-1, communications data 544-2, game data 544-3, tournament data 544-4, and/or prize data 544-5. Player data 544-1, communications data 544-2, game data 544-3, tournament data 544-4, and/or prize data 544-5 received via the input device 514 and/or the communication device 518 may, for example, be analyzed, sorted, filtered, decoded, decompressed, ranked, scored, plotted, and/or otherwise processed by the processing device 512 in accordance with the messaging instructions 542-2. In some embodiments, player data 544-1, communications data 544-2, game data 544-3, tournament data 544-4, and/or prize data 544-5 may be fed by the processing device 512 through one or more mathematical and/or statistical formulas and/or models in accordance with the messaging instructions 542-2 to determine, select, and/or utilize one or more communications channels (e.g., based on message engagement data) to provide messages to users, customers, and/or players, as described herein.

Any or all of the exemplary instructions and data types described herein and other practicable types of data may be stored in any number, type, and/or configuration of memory devices that is or becomes known. The memory device 540 may, for example, comprise one or more data tables or files, databases, table spaces, registers, and/or other storage structures. In some embodiments, multiple databases and/or storage structures (and/or multiple memory devices 540) may be utilized to store information associated with the apparatus 510. According to some embodiments, the memory device 540 may be incorporated into and/or otherwise coupled to the apparatus 510 (e.g., as shown) or may simply be accessible to the apparatus 510 (e.g., externally located and/or situated).

In some embodiments, the apparatus 510 may comprise the cooling device 550. According to some embodiments, the cooling device 550 may be coupled (physically, thermally, and/or electrically) to the processing device 512 and/or to the memory device 540. The cooling device 550 may, for example, comprise a fan, heat sink, heat pipe, radiator, cold plate, and/or other cooling component or device or combinations thereof, configured to remove heat from portions or components of the apparatus 510.

Referring now to FIG. 6A, FIG. 6B, FIG. 6C, FIG. 6D, and FIG. 6E, perspective diagrams of exemplary data storage devices 940a-e according to some embodiments are shown. The data storage devices 540a-e may, for example, be utilized to store instructions and/or data such as the game instructions 542-1, the messaging instructions 542-2, player data 544-1, communications data 544-2, game data 544-3, tournament data 544-4, and/or prize data 544-5, each of which is described in reference to FIG. 5 herein. In some embodiments, instructions stored on the data storage devices 640a-e may, when executed by a processor, cause the implementation of and/or facilitate the method 400 of FIG. 4 and/or portions thereof described herein.

According to some embodiments, the first data storage device 640a may comprise one or more various types of internal and/or external hard drives. The first data storage device 640a may, for example, comprise a data storage medium 646 that is read, interrogated, and/or otherwise communicatively coupled to and/or via a disk reading device 648. In some embodiments, the first data storage device 640a and/or the data storage medium 646 may be configured to store information utilizing one or more magnetic, inductive, and/or optical means (e.g., magnetic, inductive, and/or optical-encoding). The data storage medium 646, depicted as a first data storage medium 646a for example (e.g., breakout cross-section “A”), may comprise one or more of a polymer layer 646a-1, a magnetic data storage layer 646a-2, a non-magnetic layer 646a-3, a magnetic base layer 646a-4, a contact layer 646a-5, and/or a substrate layer 646a-6. According to some embodiments, a magnetic read head 646a may be coupled and/or disposed to read data from the magnetic data storage layer 646a-2.

In some embodiments, the data storage medium 646, depicted as a second data storage medium 646b for example (e.g., breakout cross-section “B”), may comprise a plurality of data points 646b-2 disposed with the second data storage medium 646b. The data points 646b-2 may, in some embodiments, be read and/or otherwise interfaced with via a laser-enabled read head 648b disposed and/or coupled to direct a laser beam through the second data storage medium 646b.

In some embodiments, the second data storage device 640b may comprise a CD, CD-ROM, DVD, Blu-Ray™ Disc, and/or other type of optically-encoded disk and/or other storage medium that is or becomes known or practicable. In some embodiments, the third data storage device 640c may comprise a USB keyfob, dongle, and/or other type of flash memory data storage device that is or becomes know or practicable. In some embodiments, the fourth data storage device 640d may comprise RAM of any type, quantity, and/or configuration that is or becomes practicable and/or desirable. In some embodiments, the fourth data storage device 640d may comprise an off-chip cache such as a Level 2 (L2) cache memory device. According to some embodiments, the fifth data storage device 640e may comprise an on-chip memory device such as a Level 1 (L1) cache memory device.

The data storage devices 640a-e may generally store program instructions, code, and/or modules that, when executed by a processing device cause a particular machine to function in accordance with one or more embodiments described herein. The data storage devices 640a-e depicted in FIG. 6A, FIG. 6B, FIG. 6C, FIG. 6D, and FIG. 6E are representative of a class and/or subset of computer-readable media that are defined herein as “computer-readable memory” (e.g., non-transitory memory devices as opposed to transmission devices or media).

The terms “computer-readable medium” and “computer-readable memory” refer to any medium that participates in providing data (e.g., instructions) that may be read by a computer and/or a processor. Such a medium may take many forms, including but not limited to non-volatile media, volatile media, and other specific types of transmission media. Non-volatile media include, for example, optical or magnetic disks and other persistent memory. Volatile media include DRAM, which typically constitutes the main memory. Other types of transmission media include coaxial cables, copper wire, and fiber optics, including the wires that comprise a system bus coupled to the processor.

Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable medium” and/or “tangible media” specifically exclude signals, waves, and wave forms or other intangible or transitory media that may nevertheless be readable by a computer.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined above and includes many exemplary protocols that are also applicable here.

In some embodiments, one or more specialized machines such as a computerized processing device, a server, a remote terminal, and/or a customer device may implement the various practices described herein. A computer system of a messaging (and/or game) provider may, for example, comprise various specialized computers that interact to provide for enhanced messaging services (e.g., “mailman” services), as described herein.

### VII. Rules of Interpretation

Numerous embodiments are described in this patent application, and are presented for illustrative purposes only. The described embodiments are not, and are not intended to be, limiting. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments. It is contemplated, however, that while some embodiment are not limited by the examples provided herein, some embodiments may be specifically bounded or limited by provided examples, structures, method steps, and/or sequences. Embodiments having scopes limited by provided examples may also specifically exclude features not explicitly described or contemplated.

Neither the Title (set forth at the beginning of the first page of this patent application) nor the Abstract (set forth at the end of this patent application) is to be taken as limiting in any way the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise. Similarly, any reference to an “alternate”, “alternative”, and/or “alternate embodiment” is intended to connote one or more possible variations—not mutual exclusivity. In other words, it is expressly contemplated that “alternatives” described herein may be utilized and/or implemented together, unless they inherently are incapable of being utilized together.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including the specification, its claims and figures, and anything which may be incorporated by reference, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”. In some embodiments, a first thing being “based on” a second thing refers specifically to the first thing taking into account the second thing in an explicit manner. In such embodiments, for example, a processing step based on the local weather, which itself is in some manner based on or affected by (for example) human activity in the rainforests, is not “based on” such human activities because it is not those activities that being explicitly analyzed, included, taken into account, and/or processed.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “wherein”, as utilized herein, does not evidence intended use. The term “wherein” expressly refers to one or more features inclusive in a particular embodiment and does not imply or include an optional or conditional limitation.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to allow for distinguishing that particular referenced feature from another feature that is described by the same term or by a similar term. For example, a “first widget” may be so named merely to allow for distinguishing it in one or more claims from a “second widget”, so as to encompass embodiments in which (1) the “first widget” is or is the same as the “second widget” and (2) the “first widget” is different than or is not identical to the “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; (3) does not indicate that either widget ranks above or below any other, as in importance or quality; and (4) does not indicate that the two referenced widgets are not identical or the same widget. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein. According to some embodiments, a “processor” may primarily comprise and/or be limited to a specific class of processors referred to herein as “processing devices”. “Processing devices” are a subset of processors limited to physical devices such as CPU devices, Printed Circuit Board (PCB) devices, transistors, capacitors, logic gates, etc. “Processing devices”, for example, explicitly exclude biological, software-only, and/or biological or software-centric physical devices. While processing devices may include some degree of soft logic and/or programming, for example, such devices must include a predominant degree of physical structure in accordance with 35 U.S.C. §101.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
determining, by a processing device, a level of engagement of a message recipient;
selecting, by the processing device and based on the level of engagement of the message recipient, two or more of:
(i) a target communication channel from a plurality of available communication channels;
(ii) a target device of the message recipient, from a plurality of available devices of the message recipient; and
(iii) a target message transmittal time from a plurality of available message transmittal times; and
transmitting, by the processing device and to the message recipient, a targeted electronic communication in accordance with the selected two or more of (i) the target communication channel, (ii) the target device of the message recipient, and (iii) the target message transmittal time.

2. The method of claim 1, further comprising:
sending, by the processing device and via a first electronic communication channel from the plurality of available communication channels, a first electronic communication to the message recipient; and
receiving, via the first electronic communication channel, an indication of the level of engagement of the message recipient.

3. The method of claim 1, wherein the level of engagement of the message recipient is descriptive of a level of engagement of the message recipient with respect to one or more of the communication channels from the plurality of available communication channels.

4. The method of claim 1, wherein the level of engagement of the message recipient is descriptive of a level of engagement of the message recipient with respect to one or more of devices from the plurality of available devices of the message recipient.

5. The method of claim 1, wherein the level of engagement of the message recipient is descriptive of a level of engagement of the message recipient with respect to one or more times from the plurality of available message transmittal times.

6. The method of claim 1, wherein the selecting comprises selecting the target communication channel from the plurality of available communication channels and wherein the selecting of the target communication channel comprises:
ranking the communication channels from the plurality of available communication channels based on the level of engagement of the message recipient; and
determining that the target communication channel is the highest ranked communication channel from the plurality of available communication channels.

7. The method of claim 1, wherein the selecting comprises selecting the target communication channel from the plurality of available communication channels and wherein the selecting of the target communication channel comprises:
ranking the communication channels from the plurality of available communication channels based on a communication channel cleanliness metric; and
determining that the target communication channel is the highest ranked communication channel from the plurality of available communication channels.

8. The method of claim 1, wherein the selecting comprises selecting the target device from the plurality of available devices of the message recipient and wherein the selecting of the target device comprises:
ranking the devices from the plurality of available devices of the message recipient based on the level of engagement of the message recipient; and
determining that the target device is the highest ranked device from the plurality of available devices of the message recipient.

9. The method of claim 1, wherein the selecting comprises selecting the target message transmittal time from the plurality of available message transmittal times and wherein the selecting of the target message transmittal time:
ranking the message transmittal times from the plurality of available message transmittal times based on the level of engagement of the message recipient; and
determining that the target message transmittal time is the highest ranked message transmittal times from the plurality of available message transmittal times.

10. The method of claim 1, wherein the selecting further comprises:
selecting, by the processing device and based on the level of engagement of the message recipient, a target message template from a plurality of available message templates.

11. The method of claim 10, wherein the selecting further comprises:
ranking the message templates from the plurality of available message templates based on the level of engagement of the message recipient; and
determining that the target message template is the highest ranked message template from the plurality of available message templates.

12. The method of claim 1, wherein each communication channel from the plurality of available communication channels comprises is the same type of communication channel.

13. The method of claim 12, wherein the type of communication channel comprises an e-mail communication channel type.

14. The method of claim 1, wherein the level of engagement of the message recipient is based on one or more of: (i) a message open event; (ii) a message marked-as-spam event; (iii) a click event; and (iv) a bounce event.

15. A method, comprising:
determining, by a processing device, a required reputation metric for a first communication channel;
determining, by the processing device and based on the required reputation metric for the first communication channel, a message recipient engagement parameter threshold for the first communication channel;
filtering, by the processing device and based on the message recipient engagement parameter threshold for the first communication channel, a distribution list of message recipients; and
transmitting, by the processing device and to the message recipients of the filtered distribution list and via the first communication channel, a first electronic communication.

16. The method of claim 15, further comprising:
determining, by the processing device, a listing of message recipients that were filtered from the distribution list based on the message recipient engagement parameter threshold for the first communication channel; and
transmitting, by the processing device and to the listing of message recipients that were filtered from the distribution list based on the message recipient engagement parameter threshold for the first communication channel and via a second communication channel, a second electronic communication.

17. The method of claim 16, wherein the first communication channel and the second communication channel are the same type of communication channel.

18. The method of claim 17, wherein the type of communication channel comprises an e-mail communication channel.

19. The method of claim 15, wherein the required reputation metric comprises a minimum Click-Through-Rate (CTR).

20. The method of claim 15, wherein the message recipient engagement parameter threshold comprises a threshold value for a message recipient engagement score.
